(19) United States
(12) Patent Application Publication
(10) Pub. No.: US 2017/0179860 A1
(43) Pub. Date: Jun. 22, 2017

(54) SYSTEM AND METHOD FOR CONTROLLING MOTOR STABILITY

(71) Applicant: Sentelic Corporation, Taipei City (TW)

(72) Inventors: Jao-Ching LIN, Taipei City (TW); Lin Abel CHU, Taipei City (TW); Chung-Yi SHEN, Taipei City (TW)

(21) Appl. No.: 15/375,175

(22) Filed: Dec. 12, 2016

(30) Foreign Application Priority Data
Dec. 18, 2015 (TW) 104142645

(51) Int. Cl. H02P 6/17; H02P 27/08

(52) U.S. Cl. CPC H02P 6/17; H02P 27/08

(57) ABSTRACT

A system and a method for controlling a motor are disclosed. In the present invention, the period information and the operation cycle are detected by a sensing module for calculating the variations of the rotating speed of the rotor. The duty cycle of the PWM signal corresponding to each timing segment is determined according to the predetermined power. By using the PWM signal to drive the motor, the waveform of the output current is rather smooth and close to a sinusoidal waveform, and noises of the motor are reduced effectively.

### FIELD OF THE INVENTION

The present invention is related to a method for controlling a motor, more particularly to a method and a system for controlling a motor to reduce the noises of the motor.

### BACKGROUND OF THE INVENTION

In general, it is necessary to detect the rotor position and change the phase of the current by using a phase change switch to drive a brushless-dc motor. The current is not stable during the period of phase switching, this causes the motor to resonante and produce annoying noises.

The U.S. Pat. No. 7,009,351 disclosed a control method which stops the current output during the period of phase switching, and inertia carries the rotor to rotate and pass through the point of phase switching. In this case, the single phase motor loses driving power near the point of phase switching and causes the speed of the motor to be unstable. Moreover, a circuit for detecting the predetermined period starting immediately before and ending immediately after the point of phase switching is needed.

Another U.S. Pat. No. 7,915,843 disclosed a control method to smooth the output current during the period of phase switching. In this case, it is emphasized on the modulation of current surge at the point of phase switching to prevent noises caused by the current surge. A circuit for detecting the predetermined period starting immediately before and ending immediately after the point of phase switching is also needed.

The aforementioned methods only take care of the current surge at the point of phase switching, and do not provide smooth current output to drive the motor. Consequently, it is a problem to provide smooth current output to drive a motor for preventing noises.

### SUMMARY OF THE PRESENT INVENTION

It is an objective of the present invention to provide a control method, more particularly a method and a system for controlling a motor to reduce noises.

The present invention provides a system and a method for controlling a motor, wherein a full cycle pulse-width modulation driving method is used. By using the inductance effect to output smoother and more sinusoidal-like driving current, noises of the motor are reduced.

In one embodiment of the present invention, the system for controlling a motor comprises a sensing module, a control module and a pulse-width modulation (PWM) module. The sensing module is configured to detect a period information of a rotor of the motor and generate a sensing signal. The control module is connected to the sensing module and is configured to receive the sensing signal and the period information and comprise a predetermined rule. The control module controls the PWM module to output PWM signals with proper duty cycles to drive the motor.

In one embodiment of the present invention, the method for controlling a motor comprises: detecting the period information of a rotor of the motor to obtain an operation cycle of the rotor; dividing the operation cycle into a plurality of timing segments; calculating one or more variations of the rotating speed of the rotor during the operation cycle; determining a duty cycle of a PWM signal corresponding to each timing segment according to a predetermined rule; and driving the motor with the PWM signal.

According to the aforementioned content, the system and method for controlling a motor of the present invention determine the duty cycle of the PWM signal corresponding to each timing segment according to the predetermined rule and the variations of the rotating speed. Consequently, the output current of the motor is rather smooth and close to a sinusoidal waveform because of the inductance effect, and noises of the motor are greatly reduced.

### BRIEF DESCRIPTION OF THE DRAWINGS

FIG. 1 is a schematic diagram showing a motor in accordance with one embodiment of the present invention.

FIG. 2 is a timing diagram showing the signals and current in accordance with the embodiment shown in FIG. 1.

FIG. 3 is a flowchart showing a method in accordance with one embodiment of the present invention.

### DETAILED DESCRIPTION OF THE PREFERRED EMBODIMENTS

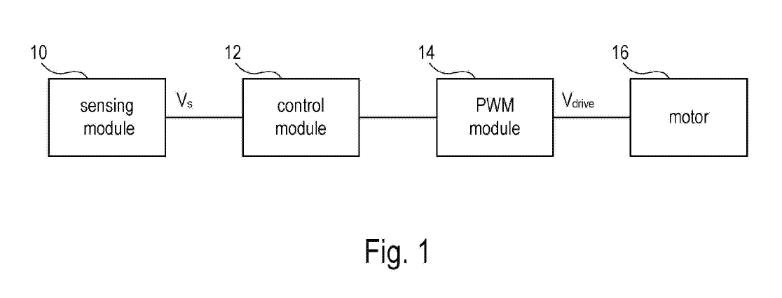

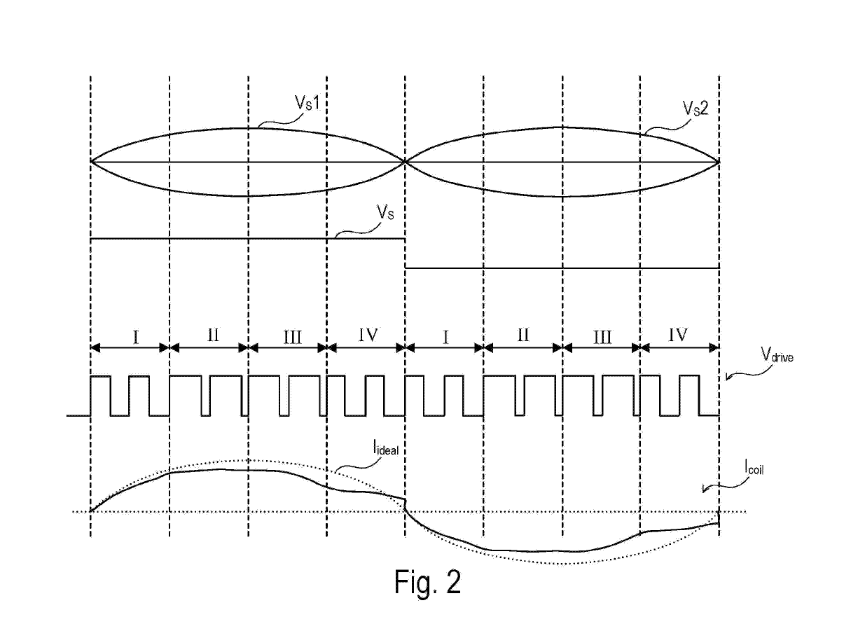

Referring to FIGS. 1 and 2, there are shown a schematic diagram of a motor in accordance with one embodiment of the present invention and a timing diagram of the signals and current in accordance with the embodiment shown in FIG. 1. In the present embodiment, the system for controlling the motor comprises a sensing module 10, a control module 12 and a pulse-width modulation (PWM) module 14. The sensing module 10 is configured to detect the period information of a rotor of the motor 16 and generate a sensing signal Vₛ. The control module 12 is connected to the sensing module 10 and is configured to receive the sensing signal Vₛ and the period information, calculate one or more variations of the rotating speed of the rotor, and comprise a predetermined rule. The control module 12 calculates the duty cycle of each time segment to control the PWM module 14. The PWM module 14 is connected to the control module 12 and is configured to generate a driving signal V_{drive} to drive the motor 16. The current I_{coil} according to the driving signal V_{drive} is smoothed because of the inductance effect of the coil of the motor 16.

In the present embodiment, the predetermined rule is a predetermined power. The motor 16 is but not limited to a single phase full wave motor. This type of motor can be used in an electric fan. The waveform of the driving current I_{coil} of the motor 16 is controlled by the driving signal V_{drive}.

In one embodiment of the present invention, the period information can be detected by sensing the variations of the magnetic field with a Hall sensor, sensing the variations of the current and sensing the counter electromotive force, to obtain the phase information of the rotor during an operation cycle.

In one embodiment of the present invention, the Hall sensor is selectively one of a Hall sensor with magnetic field transformation effect or a Hall sensor without magnetic field transformation effect.

In one embodiment of the present invention, the sensing module 10 detects the variation of the current to detect the point of phase changing.

In one embodiment of the present invention, the sensing module 10 can also detect the counter electromotive force to detect the point of phase changing.

Referring to FIG. 2, when the sensing module 10 detects the period information of the rotor, the operation cycle of the rotor is also obtained. If the motor 16 is a single phase full wave motor, the Hall sensor of the sensing module 10 firstly outputs a first sensing sinusoidal wave Vₛ₁ and a second sensing sinusoidal wave Vₛ₂, and then a comparator (or converter) of the sensing module 10 outputs a sensing signal Vₛ (squire wave). The details are well-known for the person skilled in the art and will not be discussed here.

In one embodiment of the present invention, the control module 12 obtains the operation cycle according to the sensing signal Vₛ and calculates the variations of the rotating speed of the rotor during the operation cycle according to the period information of the rotor. The control module 12 divides the operation cycle into a plurality of timing segments according to the requirement of the designer.

The control module 12 adjusts the duty cycle of the driving signal V_{drive} according to the predetermined power (predetermined rule) and the variations of the rotating speed. It is well-known for the person skilled in the art that the output power of the motor is the product of the torque and the rotating speed, and the torque and the rotating speed can be obtained from the variations of the rotating speed. Consequently, when the control module 12 receives the sensing signal Vₛ according to the period information of the rotor, the duty cycle of the driving signal V_{drive} is determined according to the variations of the rotating speed. The predetermined power determines the amplitude of the waveform of the current I_{coil}.

In the present embodiment, an operation cycle is divided into 8 timing segments (each timing segment is equal to 45 degree). The half cycle of 0-180 degree is divided into a first segment I, a second segment II, a third segment III and a fourth segment IV. The other half cycle of 181-360 degree is symmetric to the half cycle of 0-180 degree. If the predetermined power is the 60% of the max output power, the PWM module 14 outputs PWM signals with duty cycles of 35%, 75%, 75% and 35% respectively.

As shown in FIG. 2, in order to output a sinusoidal waveform (shown as the dotted line), the control module 12 calculates the duty cycle according to the predetermined power and controls the PWM module 14 to output driving signal VT_{drive} according to each timing segment. Because of the inductance effect of the coil of the motor, the output waveform of the current I_{coil} is rather smooth and close to the ideal waveform I_{ideal}. Consequently, noises of the motor are greatly reduced.

The aforementioned embodiments are only used for descriptions. It is not limited to divide the operation cycle into 8 timing segments. For example, the half operation cycle can also be divided into 5 timing segments, and the PWM module 14 outputs PWM signals with duty cycles of 80%, 40%, 40%, 20% and 20%. In one embodiment of the present invention, the timing segments are not necessary to be equal to each other.

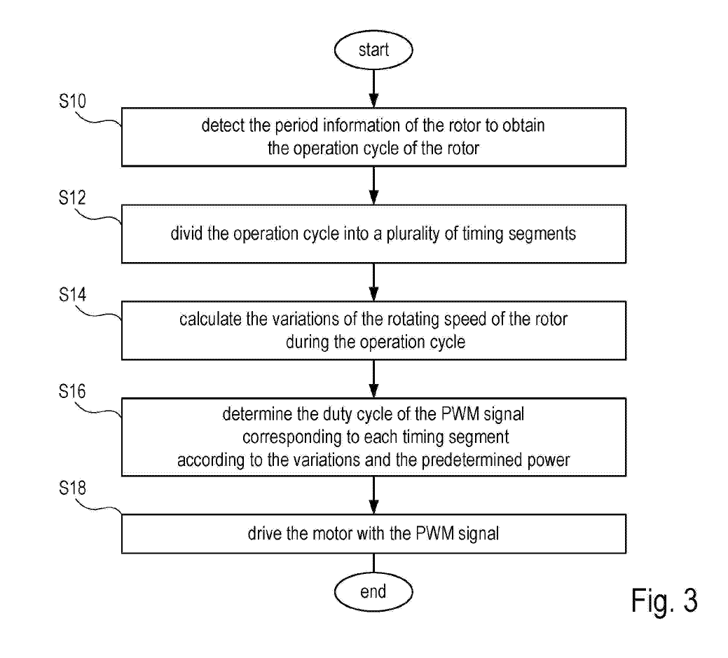

Referring to FIGS. 1-3, there is shown a flowchart of a method for controlling a motor in accordance with one embodiment of the present invention in FIG. 3. In the present embodiment, the method is adapted for the system shown in FIG. 1. The method of the present invention comprises steps of: detecting a period information of a rotor of a motor for obtaining an operation cycle of the rotor, as shown in step S10; dividing the operation cycle into a plurality timing segments, as shown in step S12; calculating variations of the rotating speed of the rotor during the operation cycle, as shown in step S14; determining the duty cycle of a PWM signal corresponding to each timing segment according to the operation cycle, a predetermined power and the variations of the rotating speed, as shown in step S16; and driving the motor with the PWM signal, as shown in step S18.

In one embodiment of the present invention, the period information of the rotor in step S10 is detected by a Hall sensor which makes use of the inductance effect of the motor 16 as the aforementioned descriptions.

In the present invention, the system and method for controlling a motor is embodied by using the sensing module to detect the period information of the rotor of the motor, calculating the variations of the rotating speed, determining the duty cycle of each timing segment according to the predetermined power, and driving the motor with the PWM signals of corresponding duty cycles. Consequently, the output current is rather smooth and close to a sinusoidal waveform, and noises of the motor are reduced effectively.

Although particular embodiments of the invention have been described in detail for purposes of illustration, various modifications and enhancements may be made without departing from the scope of the invention specified by the claims.

What is claimed is:

1. A system for controlling a motor comprising:
a sensing module configured to detect a period information of a rotor of the motor and generate a sensing signal;
a control module connected to the sensing module and configured to receive the sensing signal and the period information, calculate one or more variations of a rotating speed of the rotor and comprise a predetermined rule; and
a pulse-width modulation (PWM) module connected to the control module and configured to generate a driving signal to drive the motor according to the one or more variations and the predetermined rule.

2. The system as claimed in claim 1, wherein a coil current of the motor is controlled by the driving signal.

3. The system as claimed in claim 1, wherein the sensing module obtains a phase information of the rotor during an operation cycle by detecting a current or a counter electromotive force of the motor according to an inductance effect of the motor.

4. The system as claimed in claim 1, wherein the sensing module comprises a Hall sensor.

5. The system as claimed in claim 4, wherein the Hall sensor is selectively one of a Hall sensor with magnetic field transformation effect or a Hall sensor without magnetic field transformation effect.

6. The system as claimed in claim 1, wherein the control module calculates the one or more variations of the rotating speed of the rotor during the operation cycle according to the sensing signal.

7. The system as claimed in claim 1, wherein the predetermined rule is a predetermined power.

8. A method for controlling a motor comprising:
detecting a period information of a rotor of the motor to obtain an operation cycle of the rotor;
calculating one or more variations of a rotating speed of the rotor during the operation cycle and obtaining an estimated operation cycle;
dividing the estimated operation cycle into a plurality of timing segments;
determining a duty cycle of a pulse-width modulation (PWM) signal corresponding to each timing segment according to a predetermined rule and the one or more variations; and
driving the motor with the PWM signal.

9. The method as claimed in claim 8, wherein the period information of the rotor is detected by a Hall sensor.

10. The method as claimed in claim 8, wherein the period information of the rotor is detected by sensing a current or a counter electromotive force of the motor which makes use of an inductance effect of the motor to obtain a phase information of the rotor during an operation cycle.

11. The method as claimed in claim 8, wherein the predetermined rule is a predetermined power.
